(19) United States
(12) Patent Application Publication
(10) Pub. No.: US 2008/0100962 A1
(43) Pub. Date: May 1, 2008

(54) PERPENDICULAR MAGNETIC RECORDING MEDIUM, METHOD OF FABRICATING THE SAME, AND MAGNETIC RECORDING SYSTEM

(75) Inventor: Antony AJAN, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/848,427

(22) Filed: Aug. 31, 2007

(30) Foreign Application Priority Data
Oct. 25, 2006 (JP) 2006-290196

(51) Int. Cl. G11B 5/127

(52) U.S. Cl. 360/125.02

(57) ABSTRACT

A crystallized ferromagnetic layer containing Fe, Co and/or Ni, formed as a polycrystalline ferromagnetic layer is used as a part of the anti parallel soft under layer (APS-SUL) structure in perpendicular media to reduce the thickness of the intermediate layer. The soft under layer structure consists of a non-magnetic spacer layer, whose thickness is adjusted to form an effective anti-parallel coupling between the two ferromagnetic layers. The magnetic coupling is formed in anti-parallel directions between a lower layer made up of an amorphous ferromagnetic layer and an upper layer made up of an amorphous ferromagnetic layer and the polycrystalline ferromagnetic layer. The effective magnetization of the soft under layers at remanence is zero. The preferred thickness of the polycrystalline ferromagnetic layer is 1 nm to 20 nm. An intermediate layer, such as Ru, is formed directly on the magnetic polycrystalline soft under layer and has a thickness of about 10 nm to 20 nm. The recording magnetic layers and protective layers are formed on the intermediate layer.

### CROSS-REFERENCE TO RELATED APPLICATIONS

This application is based upon and claims the benefit of priority from the prior Japanese Patent Application No. 2006-290196, filed on Oct. 25, 2006, the entire contents of which are incorporated herein by reference.

### BACKGROUND OF THE INVENTION

1. Field of the Invention

The present invention relates to a perpendicular magnetic recording medium used for a hard disc drive, a method of fabricating the same, and a magnetic recording system.

2. Description of the Related Art

In recent years, magnetic recording media such as the hard disk are frequently used as recording media for personal computers, game machines and so on. Furthermore the demand for higher recording densities of the magnetic recording media is increasing and use of new technologies in perpendicular magnetic recording media is needed.

As in the case of the longitudinal recording, in the development of perpendicular magnetic recording media, it is important to reduce noise and improve writability at high densities. Moreover at high recording densities, a good over writability (repeated writing) is also necessary. Writability is an index of accuracy in rewriting the data. The noise from the soft under layer in the recording media has been one of the major sources of noise in perpendicular recording. Techniques for reducing noise from the soft under layer are disclosed in patent document 1 (Japanese Patent Application Laid-Open No. 2004-79043) and patent document 2 (Japanese Patent Application Laid-Open No. 2004-272957). In these techniques, a non-magnetic metal layer, such as Ruthenium, is sandwiched as a soft under layer between two ferromagnetic layers and the two ferromagnetic layers, whose magnetization lie in the plane of the film, are magnetized in opposite directions. Such a structure of a soft under layer is also called APS-SUL (anti-parallel structure in a soft under layer). The APS-SUL structure can eliminate the noise from soft under layer completely and can increase recording densities.

On a soft under layer, a separation layer made of a material such as Ta, an intermediate layer made of a material such as Ru, and a recording layer are formed. In order to improve the anisotropy of the magnetic layer and reduce noise, it is necessary to increase the thickness of the intermediate layer such as Ru. However, the intermediate layer having a large thickness reduces writability. Since noise can be reduced by using APS-SUL, the thickness of the intermediate layer can be reduced as compared with related art techniques, but still it is not possible to achieve both noise reduction and higher writability. For example, even in a perpendicular magnetic recording medium having a high recording density of 250 Gbit/inch² with APS-SUL, an intermediate layer has to be 20 nm or larger in thickness, so that it is difficult to obtain sufficient writability when high anisotropy magnetic recording layers are introduced.

### SUMMARY OF THE INVENTION

An object of the present invention is to provide a perpendicular magnetic recording medium which can achieve both noise reduction and higher writability, a method of fabricating the same, and a magnetic recording system.

After thorough study to solve the problem, the present inventor has arrived at the following modes.

A perpendicular magnetic recording medium according to the present invention includes a soft under layer, an intermediate layer formed on the soft under layer, and a recording layer formed on the intermediate layer. The soft under layer includes a first ferromagnetic layer with an amorphous structure, a second ferromagnetic layer with an amorphous structure formed above the first ferromagnetic layer, and a third ferromagnetic layer with a polycrystalline structure formed between the second ferromagnetic layer and the intermediate layer. The first ferromagnetic layer and a structure of the second and third ferromagnetic layers are magnetized in anti-parallel directions.

A magnetic recording system according to the present invention includes the above-described perpendicular magnetic recording medium. The magnetic recording system further includes a magnetic head recording and reproducing information on the perpendicular magnetic recording medium.

In a method of fabricating a perpendicular magnetic recording medium according to the present invention, a soft under layer is formed and then an intermediate layer is formed on the soft under layer. Next, a recording layer is formed on the intermediate layer. When the soft under layer is formed, a first ferromagnetic layer with an amorphous structure is formed and then a second ferromagnetic layer with an amorphous structure is formed above the first ferromagnetic layer. After that, a third ferromagnetic layer with a polycrystalline structure is formed on the second ferromagnetic layer. The first ferromagnetic layer and the structure of the second and third ferromagnetic layers are magnetized in anti-parallel directions.

### BRIEF DESCRIPTION OF THE DRAWINGS

FIG. 1 is a sectional view showing the configuration of a perpendicular magnetic recording medium according to an embodiment of the present invention.

FIG. 2 illustrates a way to use the perpendicular magnetic recording medium according to the embodiment of the present invention.

FIG. 3A shows an OSA pattern of sample No. 1.

FIG. 3B shows a magnetic anisotropy of sample No. 1.

FIG. 4A shows an OSA pattern of sample No. 2.

FIG. 4B shows a magnetic anisotropy of sample No. 2.

FIG. 5A shows an OSA pattern of sample No. 3.

FIG. 5B shows a magnetic anisotropy of sample No. 3.

FIG. 6A shows an OSA pattern of sample No. 4.

FIG. 6B shows the magnetic anisotropy of sample No. 4.

FIG. 7 shows results of a second experiment.

FIG. 8 shows results of a third experiment.

FIG. 9 shows results of a fourth experiment.

FIG. 10 shows results of a fifth experiment.

FIG. 11 shows a configuration of a magnetic recording system.

### DETAILED DESCRIPTION OF THE PREFERRED EMBODIMENTS

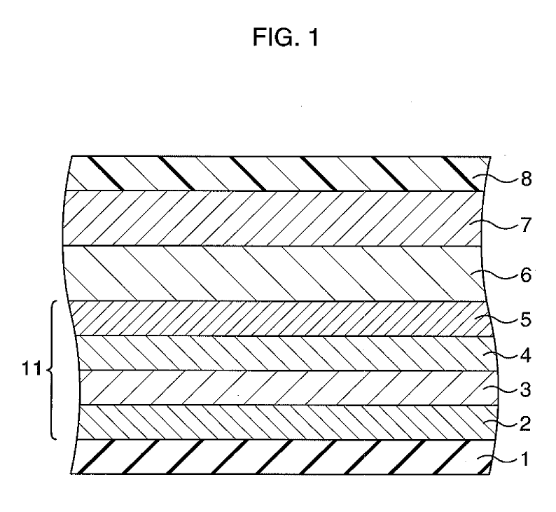

An exemplary embodiment of the present invention will now be specifically described with reference to the accompanying drawings. FIG. 1 is a sectional view showing the configuration of a perpendicular magnetic recording medium according to the embodiment of the present invention.

In the present embodiment, as shown in FIG. 1, an amorphous ferromagnetic layer 2, a spacer layer 3, an amorphous ferromagnetic layer 4, and a polycrystalline ferromagnetic layer 5 are stacked on a disk-like substrate 1. The amorphous ferromagnetic layer 2, the spacer layer 3, the amorphous ferromagnetic layer 4, and the polycrystalline ferromagnetic layer 5 make up a soft under layer 11.

As the substrate 1, for example, a plastic substrate, a crystallized glass substrate, a tempered glass substrate, a Si substrate, an aluminum alloy substrate or the like is used.

As the amorphous ferromagnetic layers 2 and 4, amorphous ferromagnetic layers containing Fe, Co and/or Ni are formed. Further, the amorphous ferromagnetic layers 2 and 4 may contain Cr, B, Cu, Ti, V, Nb, Zr, Pt, Pd and/or Ta. These elements make it possible to stabilize the amorphous states of the amorphous ferromagnetic layers 2 and 4, and improve magnetization as compared with the case where the amorphous ferromagnetic layers 2 and 4 contain only Fe, Co and/or Ni. Moreover, Al, Si, Hf and/or C may be contained. Particularly when considering the concentration of recording magnetic fields, it is preferable that the amorphous ferromagnetic layers 2 and 4 are made of soft magnetic materials having a saturation flux density Bs of 1.0 T or higher. Further, when considering writability at a high transfer rate, it is preferable that the high frequency magnetic permeability of the amorphous ferromagnetic layers 2 and 4 is high. To be specific, for example, a FeCoB layer, a FeSi layer, a FeAlSi layer, a FeTaC layer, a CoZrNb layer, a CoCrNb layer, a NiFeNb layer, and so on are available. The amorphous ferromagnetic layers 2 and 4 can be formed by, for example, a plating method, a sputtering method, an evaporation method, a CVD (chemical vapor deposition) method, and so on. When using a DC sputtering method, the inside of a chamber is kept in, for example, an Ar atmosphere of 0.5 Pa to 2 Pa. The amorphous ferromagnetic layers 2 and 4 are, for example, 5 nm to 25 nm in thickness.

As the spacer layer 3, for example, a non-magnetic metal layer containing Ru, Cu, Cr and/or the like is formed. Further, the spacer layer 3 may contain a rareearth metals such as Rh and/or Re. The spacer layer 3 can be formed by, for example, a plating method, a sputtering method, an evaporation method, a CVD (chemical vapor deposition) method, and so on. When using a DC sputtering method, the inside of a chamber is kept in, for example, an Ar atmosphere of 0.5 Pa to 2 Pa.

As the polycrystalline ferromagnetic layer 5, for example, a crystallized ferromagnetic layer containing Fe, Co and/or Ni is formed. The polycrystalline ferromagnetic layer 5 may contain Cr B and/or the like. Further, the ferromagnetic layer has, for example, a texture structure and can be formed by, for example, a plating method, a sputtering method, an evaporation method, a CVD (chemical vapor deposition) method, and so on. When using a DC sputtering method, the inside of a chamber is kept in, for example, an Ar atmosphere of 0.5 Pa to 2 Pa. Further, it is preferable that the polycrystalline ferromagnetic layer 5 is, for example, 1 nm to 20 nm in thickness. It is more preferable that the polycrystalline ferromagnetic layer 5 is 1 nm to 5 nm in thickness. When the polycrystalline ferromagnetic layer 5 is less than 1 nm in thickness, it is difficult to obtain an effect such as an improvement in crystalline orientation (described later). On the other hand, when the thickness of the polycrystalline ferromagnetic layer 5 is too large, writability may deteriorate. Polycrystalline ferromagnetic layer preferably have an fcc crystallographic structure, though it could have other structures such as bcc of hcp.

In the present embodiment, the spacer layer 3 has a thickness (for example, 0.3 nm to 3 nm) of which magnetic coupling is formed in anti-parallel directions between a lower layer made up of the amorphous ferromagnetic layer 2 and an upper layer made up of the amorphous ferromagnetic layer 4 and the polycrystalline ferromagnetic layer 5. In other words, the lower layer and the upper layer are magnetized in opposite directions and anti-ferromagnetic coupling occurs between the lower layer and the upper layer. Moreover, the relationship of “Ms₂×t₂=Ms₄×t₄+Ms₅×t₅” is established where Ms₂ represents the saturation magnetization of the amorphous ferromagnetic layer 2, t₂ represents the thickness of the amorphous ferromagnetic layer 2, Ms₄ represents the saturation magnetization of the amorphous ferromagnetic layer 4, t₄ represents the thickness of the amorphous ferromagnetic layer 4, Ms₅ represents the saturation magnetization of the polycrystalline ferromagnetic layer 5, and t₅ represents the thickness of the polycrystalline ferromagnetic layer 5. Therefore, the residual magnetization of the soft under layer 11 is zero.

Further, in the present embodiment, an intermediate layer 6 is formed directly on the soft under layer 11. The intermediate layer 6 is, for example, about 10 nm to 20 nm in thickness. Further, as the intermediate layer 6, a Ru layer whose crystal structure is a hexagonal closest packed structure (hcp) is formed, for example. The intermediate layer 6 may be a Ru—X alloy layer (X═Co, Cr, Fe, Ni and/or Mn) mainly composed of Ru with a hcp crystal structure. The intermediate layer 6 can be formed by, for example, a sputtering method, a plating method, an evaporation method, a CVD (chemical vapor deposition) method, and so on. When using a DC sputtering method, the inside of a chamber is kept in, for example, an Ar atmosphere of 0.5 Pa to 8 Pa. Further, it is preferable that the intermediate layer 6 is, for example, 5 nm to 25 nm in thickness. When the thickness of the intermediate layer 6 is less than 5 nm, noise may be insufficiently reduced. On the other hand, when the thickness of the intermediate layer 6 exceeds 25 nm, writability may deteriorate.

On the intermediate layer 6, a recording layer 7 is formed. As the recording layer 7, for example, a ferromagnetic layer mainly composed of Co and Pt is formed. Further, the recording layer 7 may contain Cr, B, SiO₂, TiO₂, CrO₂, CrO, Cu, Ti, Nb and/or the like. To be specific, a CoCrPt layer is used in which SiO₂ particles are dispersed on the grain boundary. The recording layer 7 may include a plurality of layers. The recording layer 7 can be formed by, for example, a plating method, a sputtering method, an evaporation method, a CVD (chemical vapor deposition) method, and so on. When using a DC/RF sputtering method, the inside of a chamber is kept in, for example, an Ar atmosphere of 0.5 Pa to 6 Pa. In this case, gas containing 2% to 5% oxygen is used. Further, it is preferable that the recording layer 7 is, for example, 8 nm to 20 nm in thickness.

On the recording layer 7, a protective layer 8 is formed. As the protective layer 8, for example, an amorphous carbon layer, a carbon hydride layer, a carbon nitride layer, an aluminum oxide layer or the like is formed. The protective layer 8 can be formed by, for example, a plating method, a sputtering method, an evaporation method, a CVD (chemical vapor deposition) method, and so on. When using a DC sputtering method, the inside of a chamber is kept in, for example, an Ar atmosphere of 0.5 Pa to 2 Pa. The protective layer 8 is, for example, 1 nm to 5 nm in thickness.

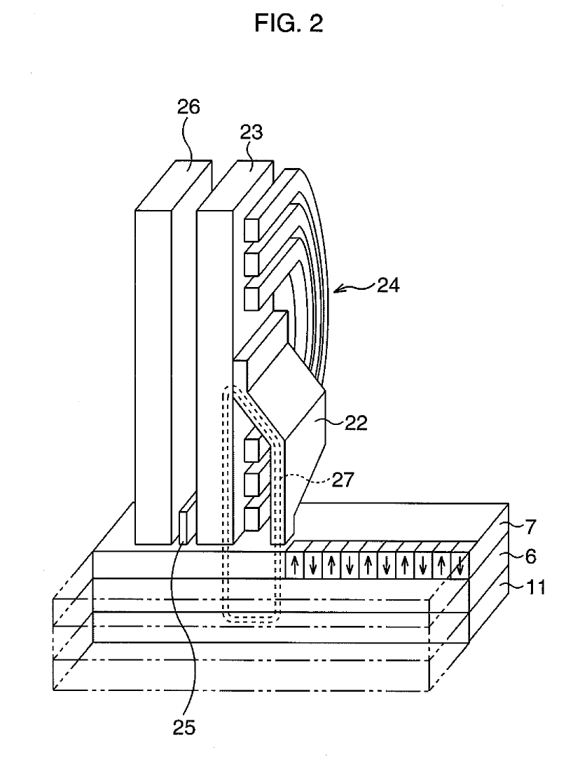

In the perpendicular magnetic recording medium configured thus, data is written (recorded) and read (reproduced) by using a magnetic head shown in FIG. 2. A magnetic head 21 for the perpendicular magnetic recording medium includes a main magnetic pole 22, an auxiliary magnetic pole 23, and a coil 24 for writing. The magnetic head 21 further includes a magnetoresistance element 25 and a shield 26 for reading. The auxiliary magnetic pole 23 also acts as a shield for the magnetoresistance element 25. When data is written, current is applied to the coil 24 and a magnetic flux 27 passing through the main magnetic pole 22 and the auxiliary magnetic pole 23 is generated. At this point, the magnetic flux 27 from the main magnetic pole 22 passes through the recording layer 7, and then the magnetic flux 27 passes through the soft under layer 11 and returns to the auxiliary magnetic pole 23. Therefore, the magnetization of the recording layer 7 changes, for each recording bit, to one of two directions (upward or downward) perpendicular to the magnetization of the recording layer 7 according to the direction of the magnetic flux.

In the present embodiment, as described above, the upper layer includes not only the amorphous ferromagnetic layer 4 but also the polycrystalline ferromagnetic layer 5. The polycrystalline ferromagnetic layer 5 with the intermediate layer 6 makes it possible to align the orientation of crystals making up the recording layer 7. Therefore, in the present embodiment, the intermediate layer 6 has a small thickness of 5 nm to 25 nm but the orientation of crystals making up the recording layer 7 is preferable. Since the intermediate layer 6 has a small thickness, excellent writability can be obtained. Further, the small thickness of the intermediate layer 6 also makes it possible to reduce the size of crystal grains making up the recording layer 7.

On the other hand, as described above, the soft under layer 11 has an APS-SUL structure in the present embodiment. Therefore, even when the intermediate layer 6 has a small thickness, noise has little influence.

As described above, according to the present embodiment, excellent writability can be obtained by forming the polycrystalline ferromagnetic layer 5 and noise can be reduced by using APS-SUL. In other words, according to the present embodiment, it is possible to achieve both higher writability and noise reduction.

Instead of the disk-like substrate 1, a tape-like film may be used as a base. In this case, as the material of the base, polyester (PE), polyethylene terephthalate (PET), polyethylene naphthalate (PEN), and polyimide (PI) having high thermal resistance can be listed.

The following will describe the contents and results of experiments having been actually conducted by the present inventor.

(First Experiment)

In the first experiment, four kinds of samples were prepared. In all of these samples, on a glass substrate, a FeCoB layer having a thickness of 25 nm and magnetization of 1.7 T was formed as the amorphous ferromagnetic layer 2, a Ru layer having a thickness of 0.4 nm was formed as the spacer layer 3, a FeCoB layer was formed as the amorphous ferromagnetic layer 4, and a NiFe layer was formed as the polycrystalline ferromagnetic layer 5. Moreover, a C layer having a thickness of 5 nm was formed on the polycrystalline ferromagnetic layer 5. As shown in Table 1, the amorphous ferromagnetic layer 4 and the polycrystalline ferromagnetic layer 5 had different thicknesses in each sample. At this point, residual magnetization on the soft under layer 11 was substantially zero in all of these samples.

TABLE 1

| | THICKNESS OF | THICKNESS OF |
|---|---|---|
| | AMORPHOUS | polycrystalline |
| SAMPLE | FERROMAGNETIC | FERROMAGNETIC |
| No. | LAYER 4 | LAYER 5 |
| 1 | 24.1 nm | 1 nm |
| 2 | 23.1 nm | 3 nm |
| 3 | 21.9 nm | 5 nm |
| 4 | 18.8 nm | 10 nm |

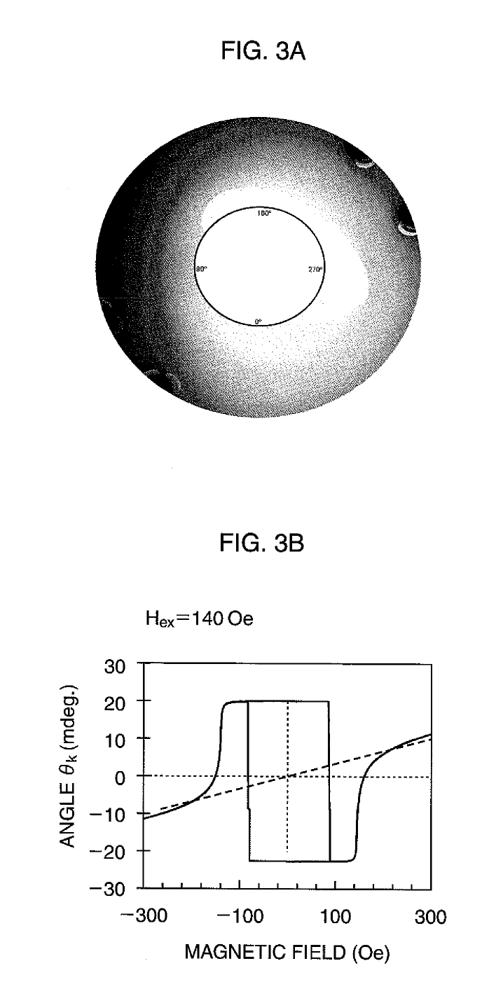

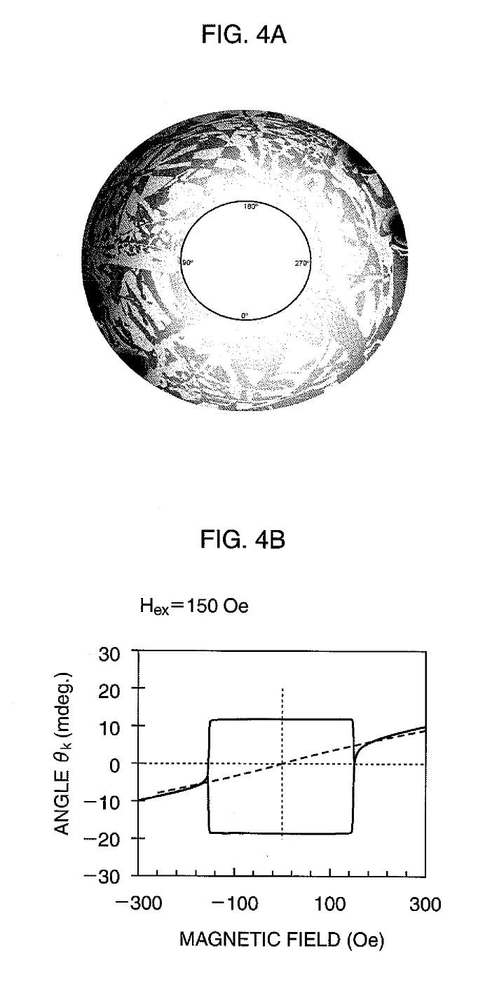

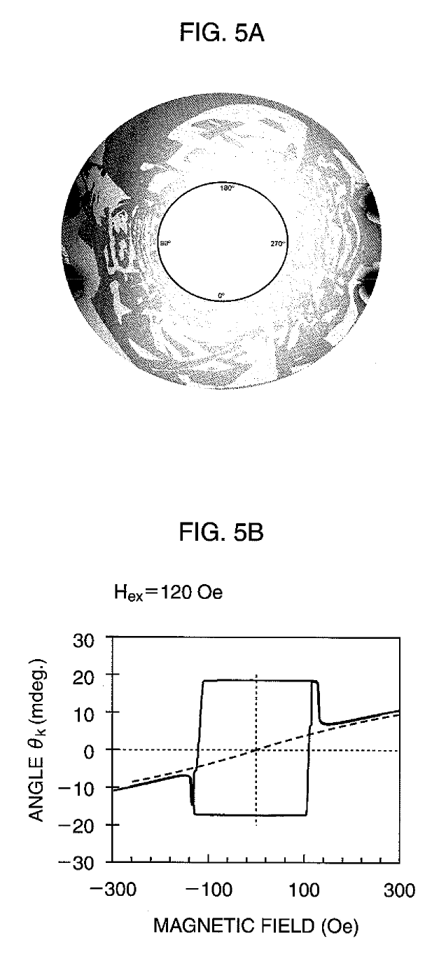

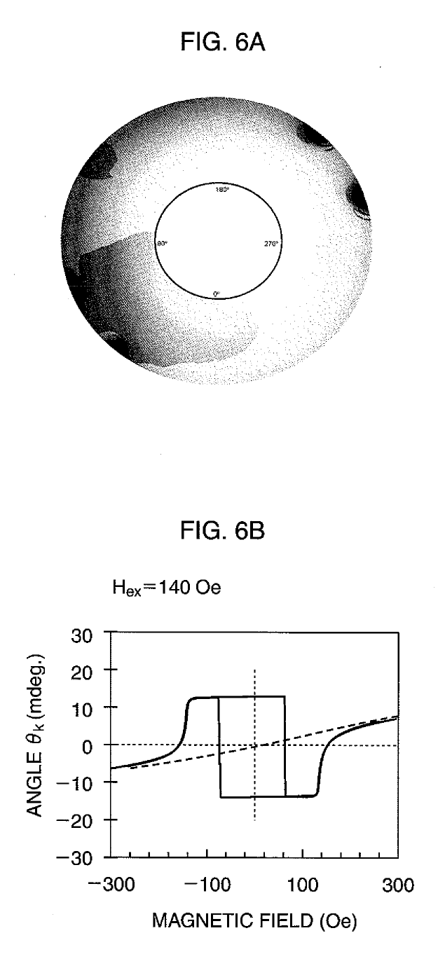

Next, an OSA (Optical Scan Analyzer) pattern was observed and magnetic anisotropy on the soft under layer 11 was examined for each sample. FIGS. 3A and 3B show results of sample No. 1, FIGS. 4A and 4B shows results of sample No. 2, FIGS. 5A and 5B show results of sample No. 3, and FIGS. 6A and 6B show results of sample No. 4. In FIGS. 3B, 4B, 5B and 6B, solid lines indicate angles of inclination of magnetization in the radial direction and broken lines indicate angles of inclination of magnetization in the circumferential direction.

In these samples, as shown in FIGS. 3A, 4A, 5A and 6A, the occurrence of magnetic domains was suppressed and the magnetic domains had extremely small sizes of 20 nm or less. As shown in FIGS. 3B, 4B, 5B and 6B, magnetic anisotropy or easy axis was aligned along the radial direction.

(Second Experiment)

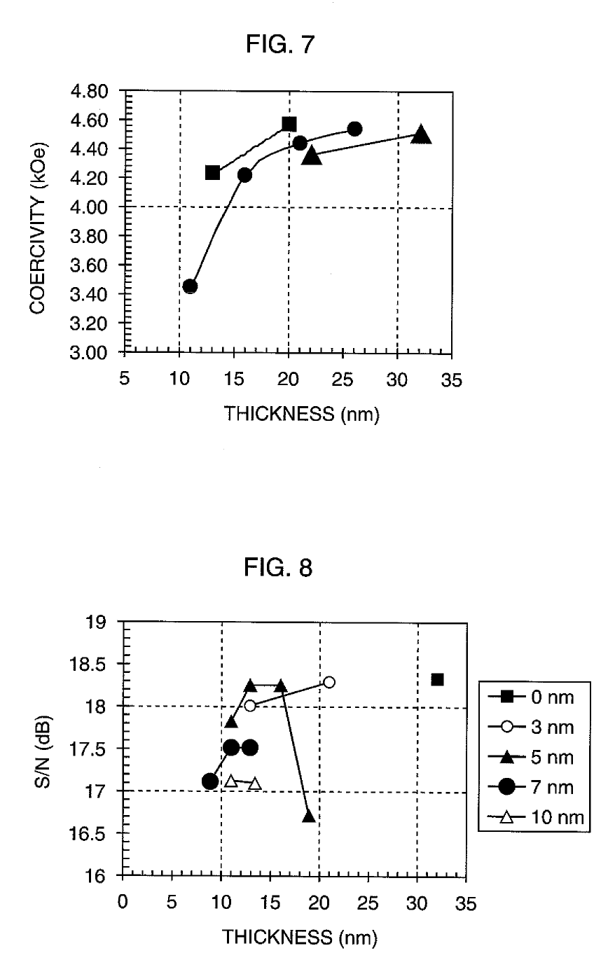

In the second experiment, the relationship between the thicknesses of the polycrystalline ferromagnetic layer 5 and the intermediate layer 6 and a coercive force was examined. The results are shown in FIG. 7. The horizontal axis of FIG. 7 represents a thickness of the intermediate layer 6 and the vertical axis of FIG. 7 represents a coercive force. Further, indicates results obtained when a NiFe layer having a thickness of 3 nm was formed as the polycrystalline ferromagnetic layer 5, and ▪ indicates results obtained when a NiFe layer having a thickness of 5 nm was formed as the polycrystalline ferromagnetic layer 5. Moreover, ▴ indicates results obtained when a laminated product was used without polycrystalline ferromagnetic layer 5. In the laminated product, a Ta layer having a thickness of 3 nm was formed on an amorphous ferromagnetic layer and a NiFe layer having a thickness of 3 nm was formed thereon. In other words, ▴ indicates results equivalent to related art techniques.

As shown in FIG. 7, even when the thickness of the intermediate layer 6 was smaller than 20 nm, a high coercive force of 4.00 kOe or higher was obtained in all of these conditions. For example, when the polycrystalline ferromagnetic layer 5 was 5 nm in thickness, a coercive force of about 4.2 Oe was obtained even when the intermediate layer 6 was about 12 nm in thickness. In the case of the sample (▴) equivalent to related art techniques, the intermediate layer 6 had to be about 32 nm in thickness to obtain a coercive force of about 4.2 kOe.

(Third Experiment)

In the third experiment, the relationship between the thicknesses of the polycrystalline ferromagnetic layer 5 and the intermediate layer 6 and the magnitude of noise was examined. The results are shown in FIG. 8. The horizontal axis of FIG. 8 represents a thickness of the intermediate layer 6 and the vertical axis of FIG. 8 represents an S/N ratio. Further, ▪ indicates results obtained when the polycrystalline ferromagnetic layer 5 was absent (corresponding to related art techniques), and ◯ indicates results obtained when a NiFe layer having a thickness of 3 nm was formed as the polycrystalline ferromagnetic layer 5. Further, ▴ indicates results obtained when a NiFe layer having a thickness of 5 nm was formed as the polycrystalline ferromagnetic layer 5, indicates results obtained when a NiFe layer having a thickness of 7 nm was formed as the polycrystalline ferromagnetic layer 5, and Δ indicates results obtained when a NiFe layer having a thickness of 10 nm was formed as the polycrystalline ferromagnetic layer 5. In the case of the sample not including the polycrystalline ferromagnetic layer 5 (▪), the thickness of the intermediate layer was set at 32 nm.

As shown in FIG. 8, in the case where the polycrystalline ferromagnetic layer 5 was formed, even when the intermediate layer 6 had a thickness smaller than 20 nm, the same result was obtained as the case where the polycrystalline ferromagnetic layer 5 was absent.

(Fourth Experiment)

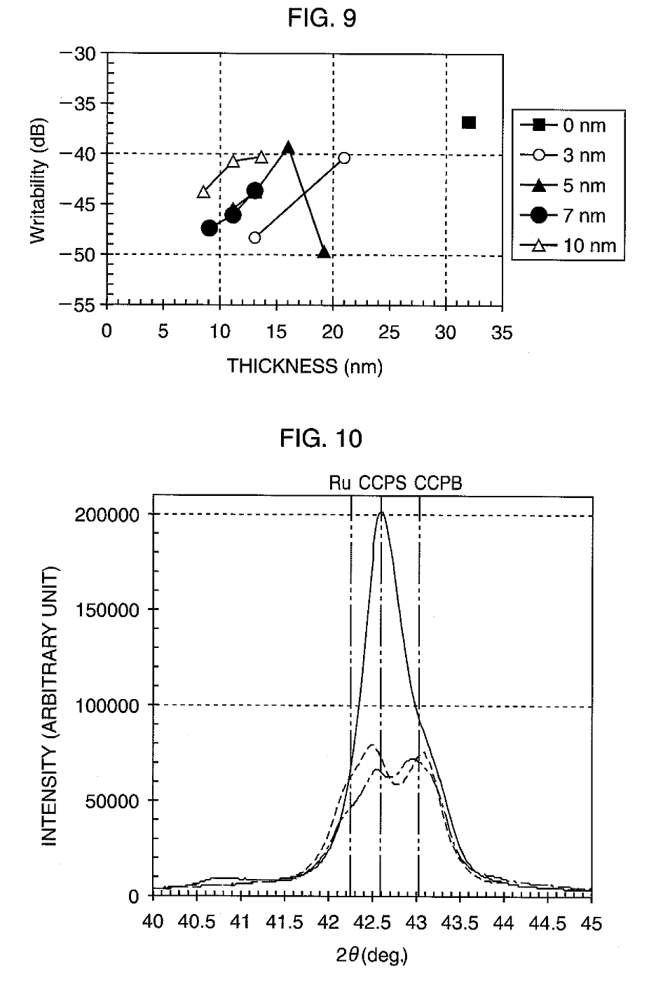

In the fourth experiment, the relationship between the thicknesses of the polycrystalline ferromagnetic layer 5 and the intermediate layer 6 and writability was examined. The results are shown in FIG. 9. The horizontal axis of FIG. 9 represents a thickness of the intermediate layer 6 and the vertical axis of FIG. 9 represents writability expressed as overwrite value. The writability was evaluated based on a ratio between the frequency of a signal read after writing at 124 kBPI and the frequency of a signal read after over writing with a 495 kBPI frequency. When this value was lower than or equal to −40 dB, excellent writability was obtained. As in FIG. 8, ▪ indicates results obtained when the polycrystalline ferromagnetic layer 5 was absent (corresponding to related art techniques), and ◯ indicates results obtained when a NiFe layer having a thickness of 3 nm was formed as the polycrystalline ferromagnetic layer 5. Further, ▴ indicates results obtained when a NiFe layer having a thickness of 5 nm was formed as the polycrystalline ferromagnetic layer 5, indicates results obtained when a NiFe layer having a thickness of 7 nm was formed as the polycrystalline ferromagnetic layer 5, and Δ indicates results obtained when a NiFe layer having a thickness of 10 nm was formed as the polycrystalline ferromagnetic layer 5. In the case of the sample not including the polycrystalline ferromagnetic layer 5 (▪), the thickness of the intermediate layer was set at 32 nm.

As shown in FIG. 9, excellent writability was obtained when the polycrystalline ferromagnetic layer 5 was formed.

(Fifth Experiment)

In the fifth experiment, a Ru layer whose surface was a (0002) plane was formed as the intermediate layer 6 and the value of Δθ₅₀ was obtained based on the X-ray diffraction. When a Cu target is used, the (0002) plane of Ru has a peak (2θ) at 42.25° and the value of Δθ₅₀ is a half-width at 42.25°. The results of the X-ray diffraction are shown in FIG. 10. In FIG. 10, a solid line indicates results obtained when the intermediate layer 6 was 32 nm in thickness, a broken line indicates results obtained when the intermediate layer 6 was 16 nm in thickness, and a chain line indicates results obtained when the intermediate layer 6 was 13 nm in thickness. Further, chain-double dashed lines indicate the peak positions of Ru, CCPC (CoCrPt—SiO₂), CCPB (CoCrPtB) respectively.

As a result of this experiment, when the intermediate layer 6 was 32 nm in thickness, Δθ₅₀ was 3.67°. When the intermediate layer 6 was 16 nm in thickness, Δθ₅₀ was 4.19°. When the intermediate layer 6 was 13 nm in thickness, Δθ₅₀ was 4.05°. This means that even when the thickness of the intermediate layer 6 was reduced to about 13 nm to 16 nm, excellent crystallinity was obtained by the action of the polycrystalline ferromagnetic layer 5.

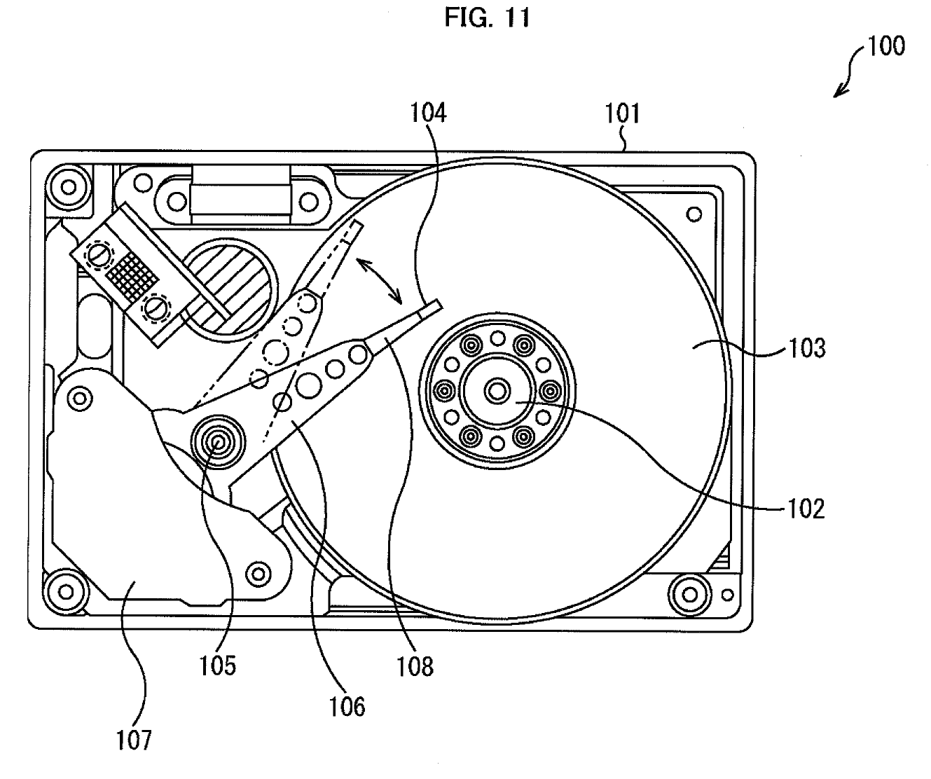

The following will describe a hard disk drive which is an example of a magnetic recording system including the perpendicular magnetic recording medium of the foregoing embodiment. FIG. 11 shows the internal configuration of the hard disk drive (HDD).

A housing 101 of a hard disk drive 100 stores a magnetic disk 103 mounted on a rotating shaft 102 and rotated about the rotating shaft 102, a slider 104 having a magnetic head recording and reproducing information on the magnetic disk 103, a suspension 108 holding the slider 104, a carriage arm 106 having the suspension 108 fixed thereon and moving with respect to an arm shaft 105 along a surface of the magnetic disk 103, and an arm actuator 107 driving the carriage arm 106. As the magnetic disk 103, the perpendicular magnetic recording medium according to the foregoing embodiment is used.

According to the present invention, the third ferromagnetic layer with a polycrystalline structure is interposed between the second ferromagnetic layer with an amorphous structure and the intermediate layer. It is thus possible to reduce noise without increasing the thickness of the intermediate layer. As a result, it is possible to achieve both noise reduction and higher writability.

What is claimed is:

1. A perpendicular magnetic recording medium, comprising:
a soft under layer;
an intermediate layer formed on said soft under layer; and
a recording layer formed on said intermediate layer,
said soft under layer, comprising:
a first ferromagnetic layer with an amorphous structure;
a second ferromagnetic layer with an amorphous structure formed above said first ferromagnetic layer; and
a third ferromagnetic layer with a polycrystalline structure formed between said second ferromagnetic layer and said intermediate layer, said first ferromagnetic layer and a structure of said second and third ferromagnetic layers being magnetized in anti-parallel directions.

2. The perpendicular magnetic recording medium according to claim 1, further comprising a non-magnetic metal layer formed between said first ferromagnetic layer and said second ferromagnetic layer.

3. The perpendicular magnetic recording medium according to claim 1, wherein said intermediate layer is made of a non-magnetic metal having a crystal structure of a hexagonal closest packed structure.

4. The perpendicular magnetic recording medium according to claim 1, wherein said intermediate layer is made of Ru or a Ru alloy.

5. The perpendicular magnetic recording medium according to claim 1, wherein said first ferromagnetic layer and said second ferromagnetic layer contain at least one element selected from a group consisting of Fe, Co, and Ni.

6. The perpendicular magnetic recording medium according to claim 5, wherein said first ferromagnetic layer and said second ferromagnetic layer further contain at least one element selected from a group consisting of Cr, B, Cu, Ti, V, Nb, Zr, Pt, Pd, and Ta.

7. The perpendicular magnetic recording medium according to claim 1, wherein said third ferromagnetic layer contains at least one element selected from a group consisting of Fe, Co, and Ni.

8. The perpendicular magnetic recording medium according to claim 7, wherein said third ferromagnetic layer further contains at least one element selected from a group consisting of Cr and B.

9. The perpendicular magnetic recording medium according to claim 1, wherein a relationship of Ms₁×t₁=Ms₂×t₂+Ms₃×t₃ is established where:
Ms₁ represents magnetization of said first ferromagnetic layer;
t₁ represents a thickness of said first ferromagnetic layer;
Ms₂ represents magnetization of said second ferromagnetic layer;
t₂ represents a thickness of said second ferromagnetic layer;
Ms₃ represents magnetization of said third ferromagnetic layer; and
t₃ represents a thickness of said third ferromagnetic layer.

10. The perpendicular magnetic recording medium according to claim 1, wherein said third ferromagnetic layer has a thickness of 20 nm or less.

11. A method of fabricating a perpendicular magnetic recording medium, comprising the steps of:
forming a soft under layer;
forming an intermediate layer on said soft under layer; and
forming a recording layer on said intermediate layer,
the step of forming said soft under layer, comprising the steps of:
forming a first ferromagnetic layer with an amorphous structure;
forming a second ferromagnetic layer with an amorphous structure above said first ferromagnetic layer; and
forming a third ferromagnetic layer with a polycrystalline structure on said second ferromagnetic layer, wherein said first ferromagnetic layer and a structure of said second and third ferromagnetic layers being magnetized in anti-parallel directions.

12. The method of fabricating the perpendicular magnetic recording medium according to claim 11, further comprising a step of forming a non-magnetic metal layer on said first ferromagnetic layer between the step of forming said first ferromagnetic layer and the step of forming said second ferromagnetic layer.

13. The method of fabricating the perpendicular magnetic recording medium according to claim 11, wherein a non-magnetic metal layer having a crystal structure of a hexagonal closest packed structure is formed as said intermediate layer.

14. The method of fabricating the perpendicular magnetic recording medium according to claim 11, wherein a Ru layer or a Ru alloy layer is formed as said intermediate layer.

15. The method of fabricating the perpendicular magnetic recording medium according to claim 11, wherein layers containing at least one element selected from a group consisting of Fe, Co, and Ni are formed as said first ferromagnetic layer and said second ferromagnetic layer.

16. The method of fabricating the perpendicular magnetic recording medium according to claim 11, wherein a layer containing at least one element selected from a group consisting of Fe, Co, and Ni is formed as said third ferromagnetic layer.

17. The method of fabricating the perpendicular magnetic recording medium according to claim 11, wherein a relationship of Ms₁×t₁=Ms₂×t₂+Ms₃×t₃ is set to be established where:
Ms₁ represents magnetization of said first ferromagnetic layer;
t₁ represents a thickness of said first ferromagnetic layer;
Ms₂ represents magnetization of said second ferromagnetic layer;
t₂ represents a thickness of said second ferromagnetic layer;
Ms₃ represents magnetization of said third ferromagnetic layer; and
t₃ represents a thickness of said third ferromagnetic layer.

18. The method of fabricating the perpendicular magnetic recording medium according to claim 11, wherein a thickness of said third ferromagnetic layer is set to be 20 nm or less.

19. A magnetic recording system, comprising:
a perpendicular magnetic recording medium including:
a soft under layer;
an intermediate layer formed on said soft under layer; and
a recording layer formed on said intermediate layer,
said soft under layer, comprising:
a first ferromagnetic layer with an amorphous structure;
a second ferromagnetic layer with an amorphous structure formed above said first ferromagnetic layer; and
a third ferromagnetic layer with a polycrystalline structure formed between said second ferromagnetic layer and said intermediate layer, said first ferromagnetic layer and a structure of said second and third ferromagnetic layers being magnetized in anti-parallel directions; and
a magnetic head recording and reproducing information on said perpendicular magnetic recording medium.
